(19) United States
(12) Patent Application Publication
(10) Pub. No.: US 2008/0207123 A1
(43) Pub. Date: Aug. 28, 2008

(54) CONFIGURABLE MEANS TO PROVIDE WIRELESS MODULE CUSTOMIZATION

(76) Inventor: Jorgen W. Andersen, Debary, FL (US)

Correspondence Address: F. CHAU & ASSOCIATES, LLC, 130 WOODBURY ROAD, WOODBURY, NY, 11797, US

(21) Appl. No.: 11/679,429

(22) Filed: Feb. 27, 2007

(51) Int. Cl. H04B 5/00

(52) U.S. Cl. 455/41.1; 381/307

(57) ABSTRACT

A wireless system, including a wireless system transmitter having a transmitter configuration device storing transmitter configuration data, and at least one wireless system receiver having a receiver configuration device storing receiver configuration data. The transmitter and receiver configuration devices include a subscriber identity module (SIM) card, a smart card, a magnetic stripe card, a barcode card, a read only memory (ROM) device, or other programmable integrated circuit device. The wireless system may be a wireless audio system and the receiver may electrically connect with an audio signal amplifier driving a speaker.

### BACKGROUND OF THE INVENTION

1. Technical Field

The present invention relates to a wireless system and, more particularly, to a wireless system having configurable module customization.

2. Discussion of the Related Art

Wireless systems are used in communication and control applications. Common applications of wireless systems include data and telephone networks, cellular telephone systems, and audio applications, such as voice or music transmission. The following exemplary description of a wireless system application is of an audio system. However, the description of an audio system should not limit the present invention.

Audio systems may be used, for example, in public address (PA) systems, home or commercial audio entertainment, or sound systems for home or commercial video entertainment. Audio systems may have multiple audio channels to provide a richer sound reproduction or to enhance sound reproduction effects, for example, to give the illusion that the listener is positioned in or near a location where the original sound was recorded. The sound reproduction may attempt to simulate the relative position of a sound source's location with respect to the listener or to simulate motion of the sound source. In a home theater surround sound system the sound reproduction may attempt, for example, to give the illusion of a locomotive in the distance, passing from the listener's right rear to the listener's left rear. Multiple speakers positioned around the listener supplied by individual audio channels are used to accomplish this effect. In setting up an audio system to best reproduce the original sound recording with the desired effects, careful positioning of the speakers and coordinating of the audio channels are performed. Specific audio channels are intended to be provided to specific speakers placed in specific positions around the listener. A modern multi-channel audio system may have left, center and right main speakers placed in front of the listener and left, center and right satellite speakers placed behind the listener. The audio system is configured to provide the appropriate channels to the desired speakers. An audio system with multiple audio channels may have speakers that provide better sound reproduction for different audio frequencies or pitches, such as treble, mid-range, or bass. Thus, some multi-channel audio systems may include a low frequency or sub-woofer speaker and other special effects speakers positioned according to the desired effects. The speakers that are intended to provide specific frequency ranges may have different drive requirements and may be driven differently by amplifiers that condition the audio signals to accommodate the specific frequency ranges and speaker types.

As stated, a conventional audio system may be configured for an optimal listening experience by connecting appropriate auditory channels output from an audio source device to intended speakers positioned in intended locations. For example, several auditory channel audio signals, including a left main channel audio signal, are produced from a CD read by a CD player. The left main channel audio signal is output from the CD player at a left main channel terminal that is connected to a left main channel input of an audio amplifier. The audio amplifier conditions and boosts the left main audio signal and outputs the conditioned and boosted left main channel audio signal through speaker connection cables to a left main speaker that is positioned according to an intended speaker layout. The intended speaker layout is a function of the type of auditor recording medium and audio reproduction system. An auditory recording medium and audio reproduction system may provide the optimal listening experience by intending to have four speakers positioned around a listener having left and right main speakers in front of the listener, separated by about fifteen feet, and left and right satellite speakers behind the listener, also separated by about fifteen feet. The type of speaker used for the left and right main speakers may be intended to provide good bass and mid-range response and the left and right satellite speakers may he intended to provide good mid-range and treble response. The audio amplifier may condition the audio signals to provide desired tonal qualities for the type of speakers being driven and also to provide a desired amplitude level for the power requirements of the type of speakers being driven. If a speaker is not positioned in an optimal location or if the speaker is of a different type than intended, the audio amplifier may condition the audio signals for that speaker to compensate for the different location or speaker type.

FIG. 1 is a block diagram of a conventional audio system. A conventional audio system 100 may have an audio source device 110, such as a microphone, musical instrument, compact disc (CD) player, radio tuner, television receiver, digital video disc (DVD) player, or movie projector, that provides audio signals. Desired audio signals may be obtained directly from the audio source device 110 or separated from combined signals as, for instance, where the audio signals are combined with a carrier frequency or with other undesired signals, or where the audio signals are combined with, for example, video signals. The desired audio signals may be input to an audio amplifier 120 where they are conditioned for tonal quality, equalization, frequency response alteration, and amplification. The audio amplifier may be directly connected to one or more speakers, such as a left main speaker 130, right main speaker 140, left satellite speaker 150, and right satellite speaker 160, by speaker connection cables 105, such as electrical wiring or coaxial cable, where the conditioned audio signals are converted into sound waves. Additionally, as indicated here, the desired audio signals may include multiple channels, e.g. left and right audio channels in a stereophonic audio system, that are separated and processed individually for sound separation effects.

To eliminate electrical wiring connecting speakers in an audio system and to allow strategic remote positioning of speakers, wireless audio systems have been developed where wireless audio system transmitters are used to wirelessly transmit the audio channels and wireless audio system receivers are used at speakers to receive the audio channels. Radio frequency transmission is used between the wireless audio system transmitters and the wireless audio system receivers, at frequencies of about, for example, 900 MHz, 2.4 GHz, or 5.8 GHz.

FIG. 2 is a block diagram of a conventional added-on wireless audio system. The conventional added-on wireless audio system 200 allows the addition of wirelessly connected speakers or the replacement of speakers with wirelessly connected speakers in an existing audio system that has an existing audio source device 110 providing audio signals to an audio amplifier 120. Instead of using speaker connection cables 105, the conventional added-on wireless audio system 200 connects a wireless audio system transmitter 210 having a transmitter antenna 215 to the existing audio amplifier 120. The conventional added-on wireless audio system 200 also includes wireless audio system receiver/driver modules, such as a left main receiver module 230, right main receiver module 240, left satellite receiver module 250, and right satellite receiver module 260, connected to the left main speaker 130, right main speaker 140, left satellite speaker 150, and right satellite speaker 160, with each, wireless audio system receiver/driver module having an internal receiver section (not shown) with, a receiver antenna 220, amplifier section (not shown), power supply (not shown), an alternating current (AC) power cord 270, and a module/speaker connection cable 280. The wireless audio system receiver/driver modules may be powered by internal batteries (not shown) and can omit AC power cords 270.

The audio channels may be amplified at the speakers whether the wireless audio system transmitter 210 is supplied with amplified or unamplified audio signals. The wireless audio system speakers have power supplies to power the receiver sections and amplifier sections.

The wireless audio system receiver sections are individually identified to receive the appropriate audio channel for the speakers with which they are connected. Each speaker or group of speakers may have individual audio channels provided by individual frequencies or by the same frequency using audio channel coding. Methods of transmitting multiple audio channels on one frequency including multiplexing systems, digital coding systems and phase shifting systems are known in the art and will not be described here. Where audio channels are provided on individual frequencies, the wireless audio system receiver sections are configured to discriminate between the frequencies to select the appropriate frequency containing the audio signals associated with the audio channel for the speaker with which it is connected. Where multiple audio channels are provided on one frequency, the wireless audio system receiver sections are configured to discriminate between the audio channels to select the appropriate audio channel for the speaker with which it is connected.

FIG. 3 is a block diagram of a conventional dedicated wireless audio system. The conventional dedicated wireless audio system 300 is a wireless audio system used where wireless capability is intended from the initial acquisition of an audio system. The conventional dedicated wireless audio system may include an audio source device 110 providing audio signals directly to a wireless audio system transmitter 210 having a transmitter antenna 215. An audio amplifier is not used because the audio signals will be amplified by dedicated receiver/driver speakers, such as a left main receiver speaker 330, right main receiver speaker 340, left satellite receiver speaker 350, and right satellite receiver speaker 360, with each dedicated speaker having an internal receiver section (not shown), amplifier (not shown), power supply (not shown), receiver antenna 220 and AC power cord 270. The dedicated speakers may be powered by internal batteries (not shown) and can omit AC power cords 270.

Wireless audio system receiver/driver modules and dedicated speakers containing a wireless audio system receiver section and amplifier section may have switches or controls for the end user to provide configuration information to the receiver section and amplifier section, or may have electronic circuitry that is permanently configured at the time of manufacture. Configuration switches and controls are costly and provide a source of failure in wireless audio systems. Permanently configured wireless audio system receiver/driver modules or dedicated speakers are identified by their intended orientation in the wireless audio system and are inventoried for sale and distribution. It is costly and inconvenient to have wireless audio system receiver/driver modules and dedicated speakers that are grouped for inventory and sale and distribution by their intended orientation in the wireless audio system. It is less expensive and more convenient to have configurable module customization available for wireless audio system receiver/driver modules and dedicated speakers.

### SUMMARY OF THE INVENTION

An exemplary embodiment of the present invention is a wireless system including a wireless system transmitter having a transmitter configuration device storing transmitter configuration data, and at least one wireless system receiver having a receiver configuration device storing receiver configuration data. The transmitter and receiver configuration devices may include a subscriber identity module (SIM) card, a smart card, a magnetic stripe card, a barcode card, a read only memory (ROM) device, or other programmable integrated circuit device. The wireless system may be a wireless audio system and the receiver may electrically connect with an audio signal amplifier driving a speaker. The at least one wireless system receiver may be located within a configurable dedicated speaker which may include a power supply. The at least one wireless system receiver may be located within a configurable receiver/driver module which may include a power supply. The transmitter and receiver configuration data may include at least one of channel frequency data, channel designation data, or channel codes. The audio signal amplifier may store audio signal conditioning data received from the receiver configuration device, receive audio signals from the at least one wireless system receiver, and condition the received audio signals according to the audio signal conditioning data. The audio signal conditioning data may include an intended location or type characteristics of the speaker. The audio signal conditioning data may include at least one of tone, frequency response or amplitude data.

An exemplary embodiment of the present invention is a method of configuring a wireless system including transferring transmitter configuration data from a transmitter configuration device to a wireless system transmitter, configuring the wireless system transmitter to transmit signals on at least one channel specified by the transmitter configuration data, transferring receiver configuration data from a receiver configuration device to a wireless system receiver, and configuring the wireless system receiver to receive signals on at least one audio channel specified by the receiver configuration data. The transmitter and receiver configuration devices may include a subscriber identity module (SIM) card, a smart card, a magnetic stripe card, a barcode card, a read only memory (ROM) device, or other programmable integrated circuit device. The transmitter and receiver configuration data may include at least one of channel frequency data, channel designation data, or channel codes. The wireless system may he a wireless audio system and the wireless system receiver may be electrically connected with an audio signal amplifier driving a speaker. The method may include transferring audio signal conditioning data from the receiver configuration device into the audio signal amplifier, and configuring the audio signal amplifier to condition the received audio signals according to the audio signal conditioning data, wherein the audio signal conditioning data includes an intended location or type characteristics of the speaker. The audio signal conditioning data may include at least one of tone, frequency response or amplitude data.

### BRIEF DESCRIPTION OF THE DRAWINGS

Exemplary embodiments of the present invention can be understood in more detail from the following descriptions taken in conjunction with the attached drawings in which:

FIG. 1 is a block diagram of a conventional audio system;

FIG. 2 is a block diagram of a conventional added-on wireless audio system;

FIG. 3 is a block diagram of a conventional dedicated wireless audio system;

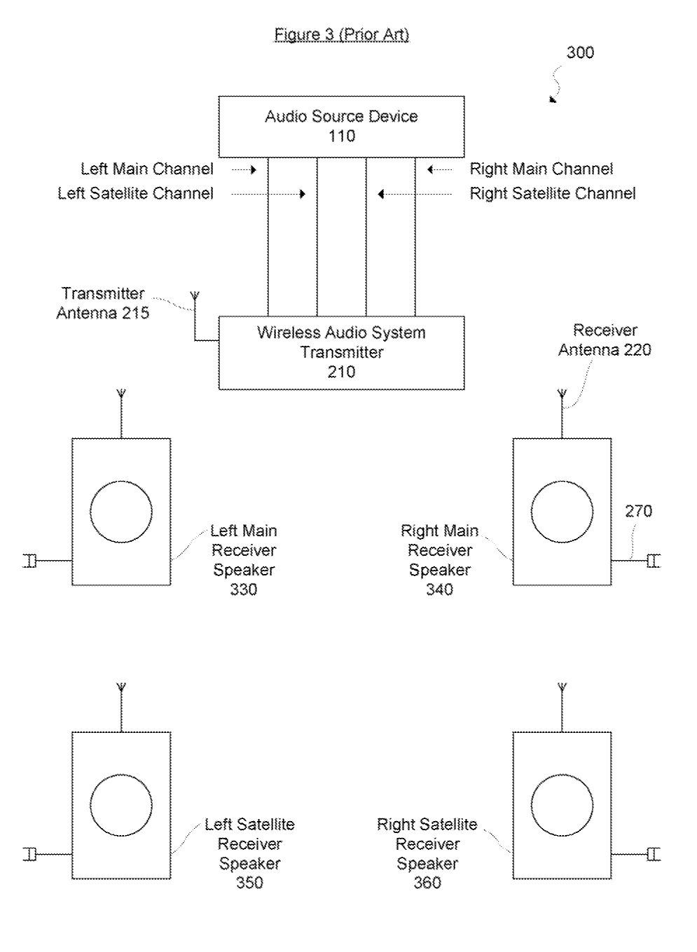

FIG. 4 is a block diagram, of a configurable wireless audio system transmitter according to an exemplary embodiment of the present invention;

FIG. 5 is a block diagram of a configurable wireless audio system receiver/driver module according to an exemplary embodiment of the present invention; and

FIG. 6 is a block diagram of a configurable wireless audio system dedicated speaker according to an exemplary embodiment of the present invention.

### DETAILED DESCRIPTION OF EXEMPLARY EMBODIMENTS

The following exemplary description of a wireless system application is of an audio system. However, it is to be understood that the present invention should not be limited to an audio system.

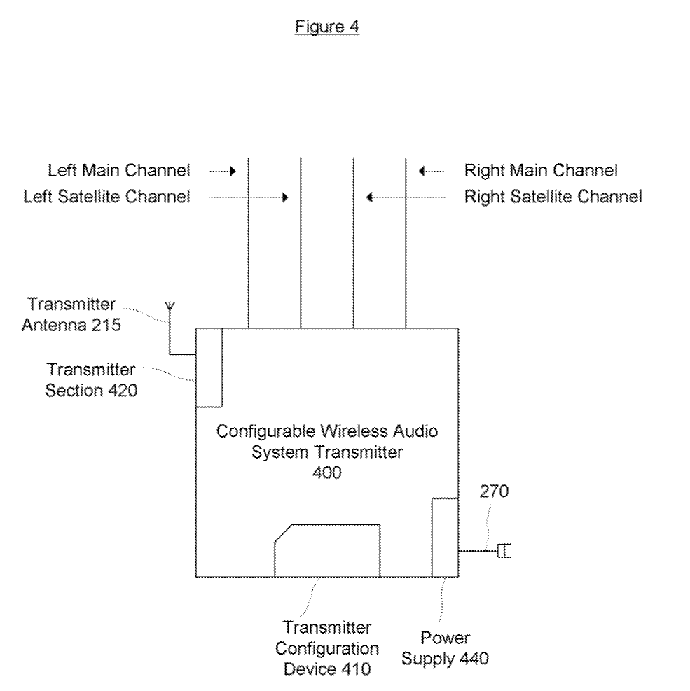

FIG. 4 is a block diagram of a configurable wireless audio system transmitter according to an exemplary embodiment of the present invention. The configurable wireless audio system transmitter 400 includes configurable wireless audio system transmitter circuitry (not shown) for the operation of the configurable wireless audio system transmitter 400, a transmitter configuration device 410, a transmitter section 420 with a transmitter antenna 215, and a power supply 440 with an AC power cord 270. The configurable wireless audio system transmitter 400 may be powered by internal batteries (not shown) and can omit the AC power cord 270. The configurable wireless audio system transmitter circuitry performs functions such as receiving the audio channel signals supplied from the audio amplifier 120 or directly from the audio source device 110, connecting with and receiving the wireless audio system configuration data from the transmitter configuration device 410, configuring the audio signals and the transmitter section 420 and outputting the audio signals to the transmitter section 420.

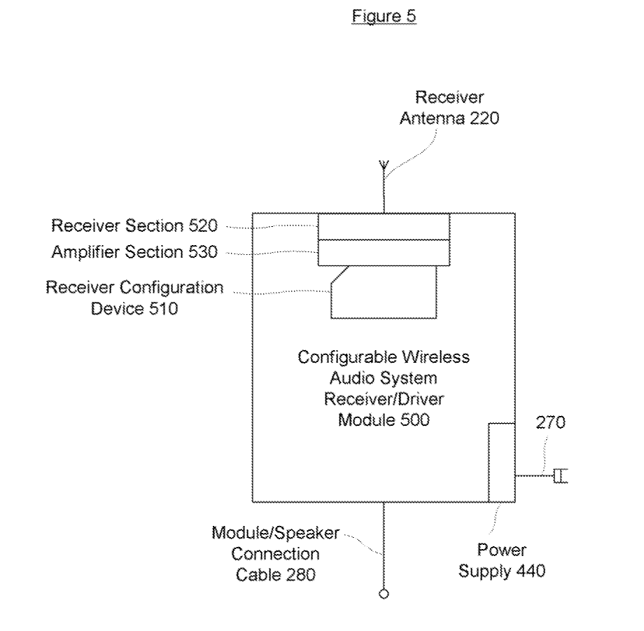

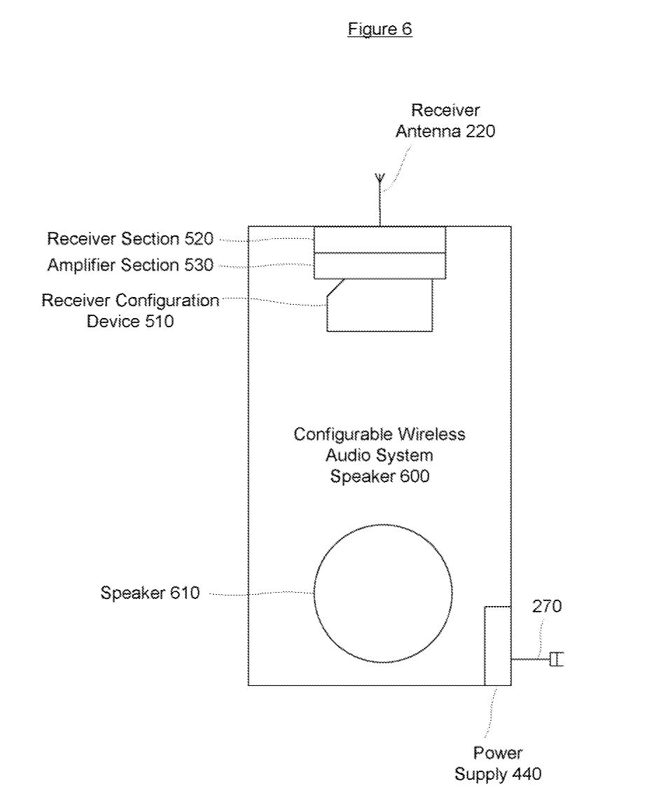

In the operation of the configurable wireless audio system transmitter 400, the audio signals for the individual audio channels are received from the audio amplifier 120 or directly from the audio source device 110. The audio signals are configured for transmission to the correct configurable wireless audio system receiver/driver module or configurable wireless audio system speaker (see FIGS. 5 and 6) using transmitter configuration data supplied to the configurable wireless audio system transmitter circuitry from the transmitter configuration device 410. The configurable wireless audio system transmitter 400 may also be used to provide wireless audio signals to existing conventional added-on or dedicated wireless audio system receiver modules or receiver speakers where the transmitter configuration device 410 is provided with appropriate transmitter configuration data. The transmitter configuration data includes the channel transmission type, number of channels, wireless audio system channel frequency data, wireless audio system channel multiplexing designation data, or wireless audio system channel codes.

The configurable wireless audio system transmitter 400 transmits the appropriate audio signal channels to the appropriate configurable wireless audio system receiver/driver modules or configurable wireless audio system speakers to drive the appropriate speakers. The configurable wireless audio system receiver/driver modules or configurable wireless audio system speakers are individually identified to receive the appropriate audio channel for the speakers with which they are connected. Each speaker or group of speakers may have individual audio channels provided by individual frequencies or by the same frequency using audio channel coding. Methods of transmitting multiple audio channels on one frequency including multiplexing systems, digital coding systems and phase shifting systems are known in the art and will not be described here.

The transmitter configuration data provides information for the configurable wireless audio system transmitter 400 to properly transmit individual audio channels to individual configurable wireless audio system receiver/driver modules or configurable wireless audio system speakers from a single transmitter section 420. The transmitter configuration data may be stored digitally in the transmitter configuration device 410 and transferred into the configurable wireless audio system transmitter 400.

In the case of a channel discrimination method having individual audio channels transmitted on individual discrete carrier frequencies, the transmitter configuration data may include the channel transmission method, number of channels, and each audio channel paired with its associated individual discrete carrier frequency. Each audio channel is modulated with its discrete carrier frequency and the modulated audio channels are then combined and transmitted together. For example, a channel discrimination method with individual discrete carrier frequencies with two channels may be identified as 12 hex, the left main audio channel identified as 01 hex may be assigned to and modulated with a 910 MHz carrier frequency identified as 01 hex and the right main audio channel identified as 02 hex may be assigned to and modulated with a 920 MHz carrier frequency identified as 02 hex, then both signals are combined and transmitted through the same transmitter section 420 and transmitter antenna 215. The configuration data in this case may have a one byte code identifying the channel discrimination method and number of channels, and a one byte channel identifier for each channel paired with a one byte carrier frequency designator for each channel, e.g., 12, 01, 01, 02, 02.

In the case of a channel discrimination method having a single carrier frequency where the individual audio channels are multiplexed, the transmitter configuration data may include the channel transmission method, number of channels, carrier frequency, and each audio channel paired with its position in the multiplexing scheme. Each audio channel is sampled according to the multiplexing scheme and combined with the other multiplexed audio signals for modulation with the carrier frequency and transmission together. For example, a channel discrimination method with a single carrier frequency with two multiplexed channels may he identified as 22 hex, the carrier frequency may be 915 MHz identified as 06 hex, the left main audio channel identified as 01 hex may be the first sampled audio channel identified as 01 hex and the right main audio channel identified as 02 hex may be the second sampled channel identified as 02 hex. The combined multiplexed audio signal is modulated with a 915 MHz carrier frequency and transmitted from the transmitter section 420 and transmitter antenna 215. The configuration data in this case may have a one byte code identifying the channel discrimination method and the number of channels, a one byte code identifying the carrier frequency, and a one byte channel identifier for each channel paired with a one byte multiplexing position designator for each channel, e.g., 22, 06, 01, 01, 02, 02.

In the case of a channel discrimination method having a single carrier frequency with individual audio channels transmitted using a digital encoding scheme, the transmitter configuration data may include the channel transmission method, number of channels, carrier frequency, and each audio channel paired with its channel code. Each audio channel may be digitized and grouped into a packet that has a code identifying it as being a packet of that channel's audio signals, then the packet is modulated with the carrier frequency and transmitted. For example, a channel discrimination method having a single carrier frequency with individual audio channels transmitted using a digital encoding scheme with two channels may be identified as 32 hex, the carrier frequency may be 915 MHz identified as 06 hex, the left main audio channel identified as 01 hex may have an assigned channel code of 77 hex, distinguishing it from the right main audio channel identified as 02 hex that may have an assigned channel code of 88 hex. Packets of each coded audio signals are then transmitted from the same transmitter section 420 and transmitter antenna 215. The configuration data in this case may have a one byte code identifying the channel discrimination method and the number of channels, a one byte code identifying the carrier frequency, and a one byte code identifying each channel paired with a one byte channel code, e.g., 32. 06, 01, 77, 02, 88.

Transmitter configuration data, such as audio channel codes, may be assigned using randomly generated numbers to reduce conflict with other nearby configurable wireless audio systems.

FIG. 5 is a block diagram of a configurable wireless audio system receiver/driver module according to an exemplary embodiment of the present invention. A configurable wireless audio system receiver/driver module 500 includes a receiver configuration device 510, a receiver section 520 with a receiver antenna 220, an amplifier section 530, a power supply 440 with an AC power cord 270, and a module/speaker connection cable 280. The configurable wireless audio system, receiver/driver module 500 may be powered by internal batteries (not shown) and can omit the AC power cord 270.

The receiver antenna 220 receives RF signals from a configurable wireless audio system transmitter 400, which are input to the receiver section 520. The receiver section 520 discriminates appropriate audio signals from the received RF signals based on receiver configuration data transferred from the receiver configuration device 510. The receiver configuration data is similar to the transmitter configuration data and includes the channel transmission type, the channel number of the configurable wireless audio system receiver/driver module 500 or configurable wireless audio system speaker in which it is installed, wireless audio system channel frequency data, wireless audio system channel designation data, or wireless audio system channel codes.

The amplifier section 530 receives the appropriate audio signals from the receiver section 520 and conditions the audio signals according to audio signal conditioning data also stored in and transferred from the receiver configuration device 510. The audio signal conditioning data differs from the transmitter and receiver configuration data in that it includes intended speaker location, speaker type characteristics, and equalization settings, such as tonal qualities, frequency response and amplitude data. Speaker type characteristics includes the type of speaker being driven which has a frequency range the speaker is intended to reproduce, such as a woofer that is intended to reproduce lower frequencies or a tweeter that is intended to reproduce higher frequencies. To optimize sound reproduction at each speaker, the amplifier is provided with the audio signal conditioning data so it can properly drive the speaker with which it is connected. Equalization settings may be provided in the form of equalization curves stored in memory (not shown) in the amplifier section 530 and selected via codes contained in the audio signal conditioning data in the receiver configuration device 510.

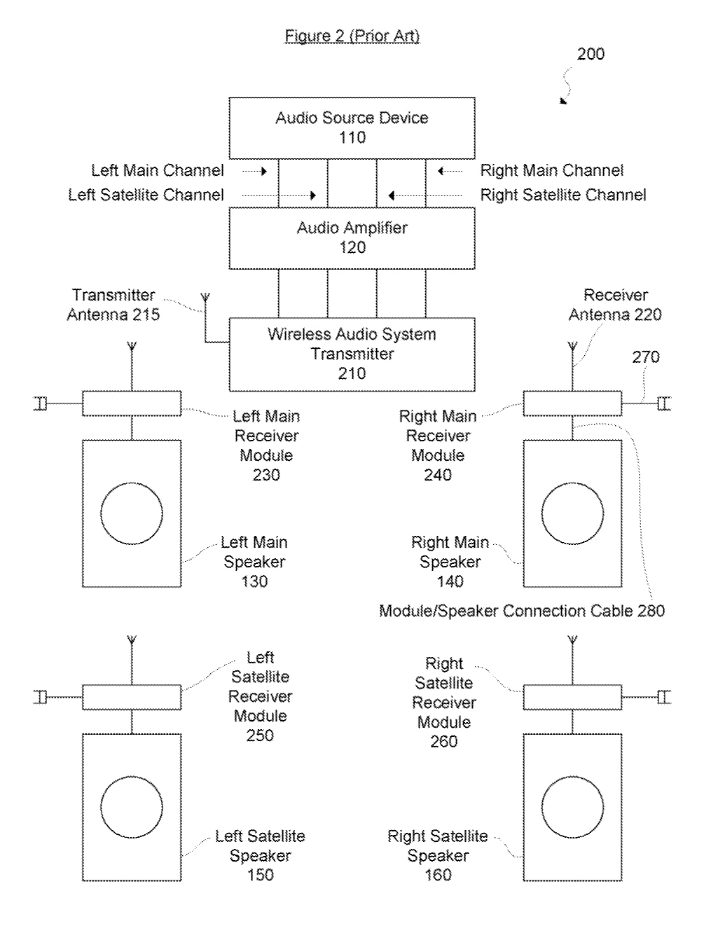

The amplifier section 530 supplies the conditioned audio signals via the module/speaker connection cable 280 to an external conventional audio speaker such as the left main speaker 130 of FIG. 2.

In the case where the configurable wireless audio system receiver/driver module 500 is used for driving the left main speaker 130 of a conventional add-on wireless audio system as in FIG. 2, the receiver configuration device 510 includes the receiver configuration data to cause the wireless audio system receiver section 520 to select the appropriate audio signals for the left main audio channel. The wireless audio system transmitter 400 may transmit, for example, the left main audio channel on a separate RF frequency from the other audio channels or it may transmit the left main audio channel on the same RF frequency as the other audio channels in an encoded format to distinguish the left main audio channel from the other audio channels. The receiver configuration device 510 located in the configurable wireless audio system receiver/driver module 500 is programmed with and supplies to the receiver section 520 the receiver configuration data enabling the receiver section 520 to select the correct RF frequency to discriminate the left main audio channel or to enable the receiver section 520 to decode the left main audio channel from the received combined audio signals.

The wireless audio system receiver sections 420 are individually identified to receive the appropriate audio channel for the speakers with which they are connected. Each speaker or group of speakers may have individual audio channels provided by individual frequencies or by the same frequency using audio channel coding. Methods of transmitting multiple audio channels on one frequency including multiplexing systems, digital coding systems and phase shifting systems are known in the art and will not be described here.

The receiver configuration data provides information for the wireless audio system receiver section 420 to properly receive and discriminate individual audio channels from configurable wireless audio system transmitters 400 transmitting multiple audio channels. The receiver configuration data may be stored digitally in the receiver configuration device 510 and transferred into the configurable wireless audio system receiver/driver module 500 or configurable wireless audio system speaker.

In the case of a channel discrimination method having individual audio channels transmitted on individual discrete carrier frequencies, the receiver configuration data may include the channel transmission method, the channel number of the configurable wireless audio system receiver/driver module 500 or configurable wireless audio system speaker, paired with its individual discrete carrier frequency. The proper audio channel is demodulated from its individual discrete carrier frequency, then amplified, conditioned and provided to the speaker with which it is connected. For example, a channel discrimination method having individual discrete carrier frequencies may be identified as 10 hex, the configurable wireless audio system receiver/driver module 500 or configurable wireless audio system speaker may be designated to provide the left main audio channel identified as 01 hex, and may be assigned to and demodulated from a 910 MHz carrier frequency identified as 01 hex. The configuration data in this case may have a one byte code identifying the channel discrimination method and a one byte channel identifier for its channel paired with a one byte carrier frequency designator for its channel, e.g., 10, 01, 01.

In the case of a channel discrimination method having a single carrier frequency where the individual audio channels are multiplexed, the receiver configuration data may include the channel transmission method, the carrier frequency, and the channel number of the configurable wireless audio system receiver/driver module 500 or configurable wireless audio system speaker, paired with its position in the multiplexing scheme. The received audio signal is demodulated from the carrier frequency, the proper audio channel is sampled according to the multiplexing scheme, then amplified, conditioned and provided to the speaker with which it is connected. For example, a channel discrimination method having a single carrier frequency where the individual audio channels are multiplexed may be identified as 20 hex, the carrier frequency may be 915 MHz identified as 06 hex, the configurable wireless audio system receiver/driver module 500 or configurable wireless audio system speaker may be designated to provide the left main audio channel identified as 01 hex, and may be the first sampled audio channel identified as 01 hex. The configuration data in this case may have a one byte code identifying the channel discrimination method, a one byte code identifying the carrier frequency, and a one byte channel identifier for the designated channel paired with a one byte code for its position in the multiplexing scheme, e.g., 20, 06, 01, 01.

In the ease of a channel discrimination method having a single carrier frequency with individual audio channels transmitted using a digital encoding scheme, the receiver configuration data may include the channel transmission method, the carrier frequency, and the channel number of the configurable wireless audio system receiver/driver module 500 or configurable wireless audio system speaker, paired with its channel code. The received audio signal is demodulated from the carrier frequency, the proper audio channel packet is discriminated from the demodulated audio signal, then converted to analog, amplified, conditioned and provided to the speaker with which it is connected. For example, a channel discrimination method having a single carrier frequency with individual audio channels transmitted using a digital encoding scheme may be identified as 30 hex, the carrier frequency may be 915 MHz identified as 06 hex, the configurable wireless audio system receiver/driver module 500 or configurable wireless audio system speaker may be designated to provide the left main audio channel identified as 01 hex, and may have a channel code of 77 hex. The configuration data in this case may have a one byte code identifying the channel discrimination method, a one byte code identifying the carrier frequency, and a one byte code for the designated channel paired with a one byte channel code, e.g., 30, 06, 01, 77.

Receiver configuration data such as audio channel codes may be assigned using randomly generated numbers to reduce conflict with other nearby configurable wireless audio systems.

Additionally, the receiver configuration device 510 may contain audio signal conditioning data to cause the amplifier section 530 to alter the audio signal for the type of speaker, e.g., left main speaker 130, used for the left main audio channel. The configurable wireless audio system receiver/driver module 500 may also be used in existing conventional added-on wireless audio systems to receive audio signals from a wireless audio system transmitter and to drive conventional speakers where the receiver configuration device is provided with appropriate receiver configuration data and audio signal conditioning data.

The audio signal conditioning data may include, for example, a one byte code identifying the speaker location, such as 01 hex for a left main speaker, a one byte code identifying the speaker type, such as 20 hex for a mid-range speaker combined with a tweeter, a one byte code identifying the speaker impedance, such as 10 hex for an 8 ohm speaker, a one byte code identifying a frequency response, such as 62 hex for a frequency response of 60 Hz-20,000 Hz, a one byte code identifying a bandwidth, such as 07 hex for a bandwidth of 7 kHz, and a one byte code identifying a crossover frequency, such as 03 hex for a crossover frequency of 3 kHz, e.g., 01, 20, 10, 62, 07, 03.

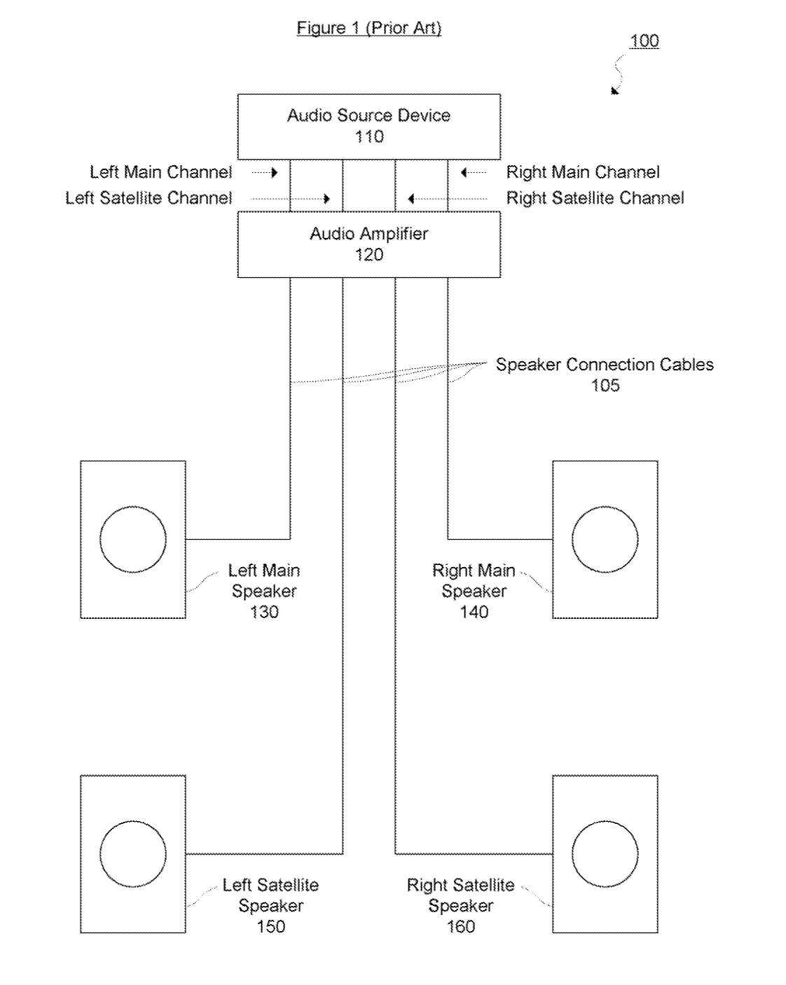

FIG. 6 is a block diagram of a configurable wireless audio system speaker according to an exemplary embodiment of the present invention. A configurable wireless audio system speaker 600 includes a receiver configuration device 510, a receiver section 520 with a receiver antenna 220, an amplifier section 530, a power supply 440 with an AC power cord 270, and a speaker 610. The configurable wireless audio system speaker 600 may be powered by internal batteries (not shown) and can omit, the AC power cord 270. The configurable wireless audio system speaker 600 is essentially a combination of the configurable wireless audio system receiver/driver module 500 of FIG. 5 and a conventional audio speaker, such as the left main speaker 130 of FIG. 1. The configurable wireless audio system speaker 600 eliminates external electrical wiring in a more compact form factor. The configurable wireless audio system speaker 600 may also be used in existing conventional dedicated wireless audio systems to receive audio signals from a wireless audio system transmitter and to provide sound reproduction where the receiver configuration device is provided with appropriate receiver configuration data and audio signal conditioning data.

The transmitter and receiver configuration devices 410 and 510 contain the transmitter and receiver configuration data and the audio signal conditioning data for the configurable wireless audio system transmitter 400 of FIG. 4, the configurable wireless audio system receiver/driver module 500 of FIG. 5 and the configurable wireless audio system speaker 600 of FIG. 6. The transmitter and receiver configuration devices 410 and 510 are a form of removable non-volatile memory that may be implemented as, for example, a subscriber identity module (SIM) card, a smart card, a magnetic stripe card, a barcode card, a type of read only memory (ROM) device, or any type of programmable integrated circuit, such as a programmable logic array (PLA).

A subscriber identity module (SIM) card is a type of smart card that has a compact form factor, non-volatile memory, and may have processing capabilities. A SIM card may be used to store data in electronic devices, such as mobile phones, personal digital assistants (PDAs), personal computers (PCs), digital televisions, and public web kiosks, in mobile phone usage the SIM card may store subscriber data, as well as subscription information, preferences and text messages.

There are several types of ROM devices that may be used to implement the transmitter and receiver configuration devices 410 and 510, such as programmable ROM (PROM), erasable PROM (EPROM), electrically alterable ROM (EAROM), and electrically erasable PROM (EEPROM), such as flash memory.

The transmitter and receiver configuration devices 410 and 510 may be installed into the configurable wireless audio system transmitter 400, the configurable wireless audio system receiver/driver module 500, and the configurable wireless audio system speaker 600 at the time of manufacture, when sold, upon installation, or when updates are made to the configurable wireless audio system. The transmitter and receiver configuration devices 410 and 510 may be mounted into connection receptacles (not shown), such as a SIM card receptacle, a smart card receptacle, a magnetic stripe card reading receptacle, a barcode card reading receptacle, or an integrated circuit chip socket, contained in the respective configurable wireless audio system components.

The transmitter and receiver configuration devices 410 and 510 may contain additional data to provide error detection and correction. Error detection and correction data may be used with error detection and correction algorithms to ensure that transmitter and receiver configuration data and audio signal conditioning data read from the transmitter and receiver configuration devices 410 and 510 is transferred correctly. Error detection and correction data may also be used to ensure that audio signals sent from the transmitter section 420 to the receiver sections 520 is transferred correctly.

Transmitter and receiver configuration devices 410 and 510 may be supplied as packages, such as in sets of magnetic stripe or barcode cards. A factory database may contain card set information associated with the serial numbers of the produced units or with any other type of additional correlation data, such as invoice numbers. The card set information contains the initial configuration information for an audio system. The configuration information is not permanent and can be changed, such as in a case where it is taught to the audio system during or after installation, or in a case of interference with a neighboring audio system. Configuration information may contain a unique randomly generated identifying code for each audio system where the individual audio system components are mated when produced or when taught during installation. The identifying code may be stored in a 24 bit code providing over 16 million possible combinations.

While the present invention has been particularly shown and described with reference to exemplary embodiments thereof, it will he understood by those of ordinary skill in the art that various changes in form and details may be made therein without departing from the spirit and scope of the present invention as defined by the following claims.

What is claimed is:

1. A wireless system, comprising:
a wireless system transmitter having a transmitter configuration device storing transmitter configuration data; and
at least one wireless system receiver having a receiver configuration device storing receiver configuration data.

2. The wireless system of claim 1, wherein the transmitter and receiver configuration devices include a subscriber identity module (SIM) card, a smart card, a magnetic stripe card, a barcode card, a read only memory (ROM) device, or other programmable integrated circuit device.

3. The wireless system of claim 1, wherein the wireless system is a wireless audio system and the receiver electrically connects with an audio signal amplifier driving a speaker.

4. The wireless audio system of claim 3, wherein the at least one wireless system receiver is located within a configurable dedicated speaker.

5. The wireless audio system of claim 4, wherein the configurable dedicated speaker includes a power supply.

6. The wireless system of claim 1, wherein the at least one wireless system receiver is located within a configurable receiver/driver module.

7. The wireless system of claim 6, wherein the configurable receiver/driver module includes a power supply.

8. The wireless system of claim 1, wherein the transmitter and receiver configuration data includes at least one of channel frequency data, channel designation data, or channel codes.

9. The wireless audio system of claim 3, wherein the audio signal amplifier stores audio signal conditioning data received from the receiver configuration device, receives audio signals from the at least one wireless system receiver, and conditions the received audio signals according to the audio signal conditioning data.

10. The wireless audio system of claim 9, wherein the audio signal conditioning data includes an intended location or type characteristics of the speaker.

11. The wireless audio system of claim 9, wherein the audio signal conditioning data includes at least one of tone, frequency response or amplitude data.

12. A method of configuring a wireless system, comprising:
transferring transmitter configuration data from a transmitter configuration device to a wireless system transmitter;
configuring the wireless system transmitter to transmit signals on at least one channel specified by the transmitter configuration data;
transferring receiver configuration data from a receiver configuration device to a wireless system receiver; and
configuring the wireless system receiver to receive signals on at least one channel specified by the receiver configuration data.

13. The method of claim 12, wherein the transmitter and receiver configuration devices include a subscriber identity module (SIM) card, a smart card, a magnetic stripe card, a barcode card, a read only memory (ROM) device, or other programmable integrated circuit device.

14. The method of claim 12, wherein the transmitter and receiver configuration data includes at least one of channel frequency data, channel designation data, or channel codes.

15. The method of claim 12, wherein the wireless system is a wireless audio system and the wireless system receiver is electrically connected with an audio signal amplifier driving a speaker.

16. The method of claim 15, further comprising:
transferring audio signal conditioning data from the receiver configuration device into the audio signal amplifier; and
configuring the audio signal amplifier to condition the received audio signals according to the audio signal conditioning data.

17. The method of claim 16, wherein the audio signal conditioning data includes an intended location or type characteristics of the speaker.

18. The method of claim 16, wherein the audio signal conditioning data includes at least one of tone, frequency response or amplitude data.
